(19) United States
(12) Patent Application Publication
(10) Pub. No.: US 2019/0313053 A1
(43) Pub. Date: Oct. 10, 2019

(54) VIDEO LINK SYSTEM FOR MULTIPLE DISPLAYS

(71) Applicant: Visteon Global Technologies, Inc., Van Buren Township, MI (US)

(72) Inventors: Sophie Chané, Seine (FR); Stéphane Voillot, Courdimanche (FR); Francis Lehomme, Cergy (FR); Julien Fouques, Cergy (FR); Christophe Kerveillant, Cergy (FR); Mikael Capp, Changé (FR); Christian Noel, Cergy (FR)

(21) Appl. No.: 15/946,033

(22) Filed: Apr. 5, 2018

(51) Int. Cl. H04N 7/10; H04N 21/414; H04N 21/4363; H04N 21/434; H04N 21/4402; H04N 5/445; H04N 5/63; H04N 21/44

(52) U.S. Cl. CPC H04N 7/106; H04N 21/41422; H04N 21/43635; H04N 21/44004; H04N 21/4402; H04N 5/44591; H04N 5/63; H04N 21/434

(57) ABSTRACT

A video link system and method of providing video are provided. The system includes a head unit that has a controller and a serializer for serializing video output from the controller and outputting a serial video stream. At least one display assembly is coupled to the head unit and includes at least one display panel for displaying the video output from the head unit. The at least one display assembly includes a deserializer for deserializing the serial video stream from the serializer of the head unit and outputting an intermediate digital display stream. The at least one display assembly also includes an unpacking unit coupled to the deserializer and to the at least one display panel. The unpacking unit is configured to process the intermediate digital display stream from the deserializer and output an unpacked digital display output to the at least one display panel.

### BACKGROUND

Display assemblies are commonly used in vehicles to present images and video for infotainment and instrumentation purposes. Such display assemblies can be found as part of human machine interface (HMI) devices including instrument clusters, heads-up displays (HUDs), and central information displays (CIDs) and are typically connected to a single head unit. Some HMI devices themselves, such as instrument clusters, can also include multiple display assemblies within that device's housing or coupled thereto. In general, the number of display assemblies found in typical vehicle cockpits is increasing as additional applications of display assemblies arise. Yet, the increasing quantity of display assemblies can necessitate additional connectors and wiring in the vehicle and specifically on the head unit itself, since vehicle head units may also include other connectors for vehicle loudspeakers, antennas, and cameras, for example. The video formats provided from the head unit to the various display assemblies of the vehicle may also be different from one another.

Additionally, known instrument clusters can display safety-related information in the form of physical telltales (i.e., separate indicator lamps) and in some cases, these telltales can also be drawn as an icon on display assemblies in the vehicle. Nevertheless, safety requirements exist to ensure that safety-related information is properly conveyed to the vehicle operator and/or passengers. One such safety requirement is ISO 26262 which provides for functional safety of electrical and/or electronic systems in vehicles. Thus, it can be necessary to confirm or check that the correct telltale is displayed at the right time and place on the appropriate display assembly.

### SUMMARY

This section provides a general summary of the disclosure and is not a comprehensive disclosure of its full scope or all of its features, aspects or objectives.

A video link system for multiple displays is provided. The video link system includes a head unit that has a controller for outputting video and a serializer coupled to the controller to serialize the video output from the controller and output a serial video stream. At least one display assembly is coupled to the head unit and includes at least one display panel to display video output from the head unit. The at least one display assembly includes a deserializer to deserialize the serial video stream from the serializer of the head unit and output an intermediate digital display stream. The at least one display assembly also includes an unpacking unit coupled to the deserializer and to the at least one display panel. The unpacking unit is configured to process the intermediate digital display stream from the deserializer. In addition, the unpacking unit is configured to output an unpacked digital display output to the at least one display panel.

The at least one display panel of the video link system can also define a display area and the intermediate digital display stream can include a region of interest to be displayed on a portion of the display area. The processing of the intermediate digital display stream from the deserializer of the unpacking unit includes computing a check sum for the region of interest.

The processing of the intermediate digital display stream from the deserializer of the unpacking unit of the video link system can also include communicating the check sum to the deserializer to be sent back to the controller of the head unit. The controller of the head unit is configured to compute an expected check sum for the serial video stream corresponding to the region of interest. The controller of the head unit is configured to compare the check sum to the expected check sum.

The region of interest of the video link system can correspond to one of a telltale and a warning message.

The controller of the head unit video link system can also be configured to process a plurality of designated video frames for outputting to the at least one display assembly using the controller of the head unit and pack the plurality of designated video frames into the video output using controller of the head unit.

The unpacking unit of the video link system can include at least one line buffer for processing the intermediate digital display stream. Additionally, the unpacking unit can includes a plurality of unpacking unit outputs and the plurality of unpacking unit outputs includes a plurality of low voltage differential signaling display interface outputs. The low voltage differential signaling display interface outputs can include an even low voltage differential signaling display interface output and an odd low voltage differential signaling display interface output.

The head unit of the video link system can include a plurality of video output ports for outputting the serial video stream and the plurality of video output ports of the head unit are adapted to output power along with the serial output stream.

The serializer of the head unit and the deserializer of the at least one display assembly can be of the type to communicate via a Gigabit Multimedia Serial Link and the serial video stream can be a Gigabit Multimedia Serial Link video stream.

A display assembly for displaying video from a head unit is also provided. The display assembly includes at least one display panel and a video input port coupled to the at least one display panel to display video output from the head unit. A deserializer is electrically connected to the video input port and includes a plurality of deserializer output ports to deserialize the serial video stream from the serializer of the head unit and output an intermediate digital display output on the plurality of deserializer output ports. An unpacking unit has a plurality of unpacking unit inputs electrically connected to the plurality of deserializer output ports and has a plurality of unpacking unit outputs electrically connected to the at least one display panel to process the intermediate digital display output from the deserializer and output an unpacked digital display output on the plurality of unpacking unit outputs to the at least one display panel.

The display assembly can further include an interposed output port and a secondary serializer coupled to the interposed output port and to the plurality of unpacking unit outputs for serializing the unpacked digital display output from the plurality of unpacking unit outputs and outputting a secondary serial video stream on the interposed output port. The at least one ancillary display unit can be coupled to the interposed output port and can include an ancillary deserializer coupled to the interposed output port and an ancillary display panel coupled to the ancillary deserializer.

The unpacking unit of the display assembly can include at least one line buffer for processing the intermediate digital display stream.

The intermediate digital display stream of the display assembly can include a region of interest to be displayed on a portion of the display area. The processing of the intermediate digital display stream from the deserializer of the unpacking unit can include computing a check sum for the region of interest.

The unpacking unit can be a field programmable gate array.

A method of providing video to at least one display assembly from a head unit is additionally provided. The method begins with the step of outputting a video output from a controller of the head unit to a serializer. Next, serializing the video output to a serial video stream using the serializer. The method proceeds by outputting the serial video stream on one of a plurality of video output ports of the head unit. The next step of the method is receiving the serial video stream with a deserializer of at least one display assembly. Then, the method continues with the step of deserializing the serial video stream to an intermediate digital display stream using the deserializer. The method also includes the step of outputting the intermediate digital display stream on a plurality of deserializer ports. The method continues with the steps of receiving the intermediate digital display stream with an unpacking unit coupled to the plurality of deserializer ports and processing the intermediate digital display stream using the unpacking unit. The method concludes with the step of outputting an unpacked digital display output on a plurality of unpacking unit outputs to at least one display panel.

Thus, the video link system for multiple displays according to the disclosure provides various advantages. Specifically, a reduced number of connectors at the head unit and human machine interface (HMI) device level and cables interconnecting these components are necessary. Additionally, the video link system provided in the disclosure confirms or checks that the correct telltale is displayed at the right time and place on the appropriate display assembly, ensuring compliance with vehicle safety requirements.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all implementations, and are not intended to limit the present disclosure to only that actually shown. With this in mind, various features and advantages of example embodiments of the present disclosure will become apparent from the written description when considered in combination with the appended Figures, wherein:

FIG. 1 illustrates an example of a known head unit including video output ports corresponding to a number of display assemblies to be coupled to the head unit;

FIG. 2 illustrates a first embodiment of a video link system in which the video output ports of the head unit are adapted to output power along with a serial output stream to a proximity display and a central information display according to aspects of the disclosure;

FIG. 3 illustrates the first embodiment of the video link system in which the video output ports of the head unit are adapted to output power along with a serial output stream to a cluster and the proximity display according to aspects of the disclosure;

FIG. 4 illustrates the first embodiment of the video link system and shows a deserializer and unpacking unit of the cluster coupled to a first cluster display panel and a second cluster display panel according to aspects of the disclosure;

FIG. 5 illustrates a region of interest of a portion of a display area of at least one of the display assemblies according to aspects of the disclosure;

FIG. 6 illustrates a second embodiment of the video link system in which an unpacking unit is coupled to a single display panel according to aspects of the disclosure;

FIG. 7 illustrates a third embodiment of the video link system in which the video link system includes an ancillary display unit according to aspects of the disclosure;

FIG. 8 illustrates the third embodiment of the video link system and shows a secondary serializer of the at least one display assembly and an ancillary serializer of the ancillary display unit according to aspects of the disclosure; and

FIGS. 9A, 9B, and 10 illustrate steps of a method of providing video to the at least one display assembly from the head unit according to aspects of the disclosure.

### DETAILED DESCRIPTION

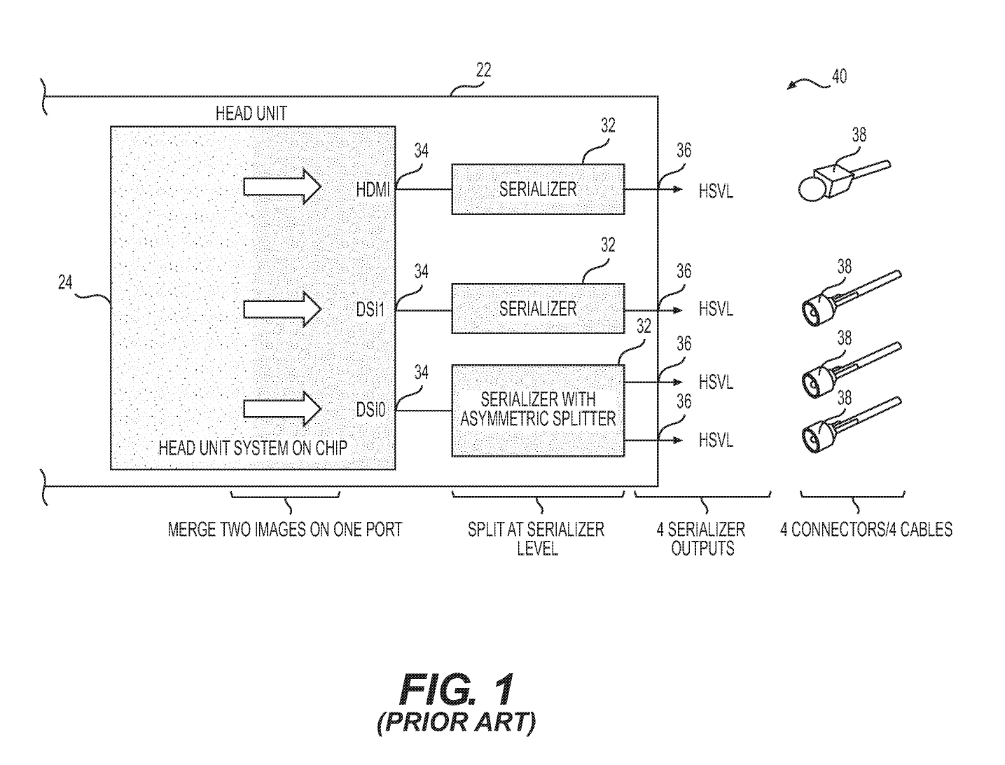

In the interest of providing necessary information to the driver and/or passenger of a vehicle, multiple display assemblies are utilized in the cockpit of the vehicle. These various display assemblies are coupled to a common head unit, which provides a video output to each of the display assemblies. For example, as shown in FIG. 1, a known head unit 22 is illustrated with a controller 24 or system on chip (SOC) which outputs video to a plurality of serializers 32 through a plurality of data ports 34. The controller 24 may also merge images or video on one of the plurality of data ports 34. The plurality of serializers 32 are coupled to a plurality of video output ports 36. In the event that one of the plurality of serializers 32 is connected to one of the plurality of data ports 34 in which multiple images or video is merged, the serializer 32 can be a serializer 32 with an asymmetric splitter, as shown. Nevertheless, using one video output port 36 for each display assembly 20 requires commensurate quantities of electrical connectors 38 (Fakra RF connector or coaxial type connector) and cabling to interconnect each display assembly 20 to the head unit 22. Increasing numbers of electrical connectors 38 and cabling can lead to video link systems 40 which are more complicated and expensive to manufacture. Furthermore, the use of serializers 32 with asymmetric splitters can also be undesirable.

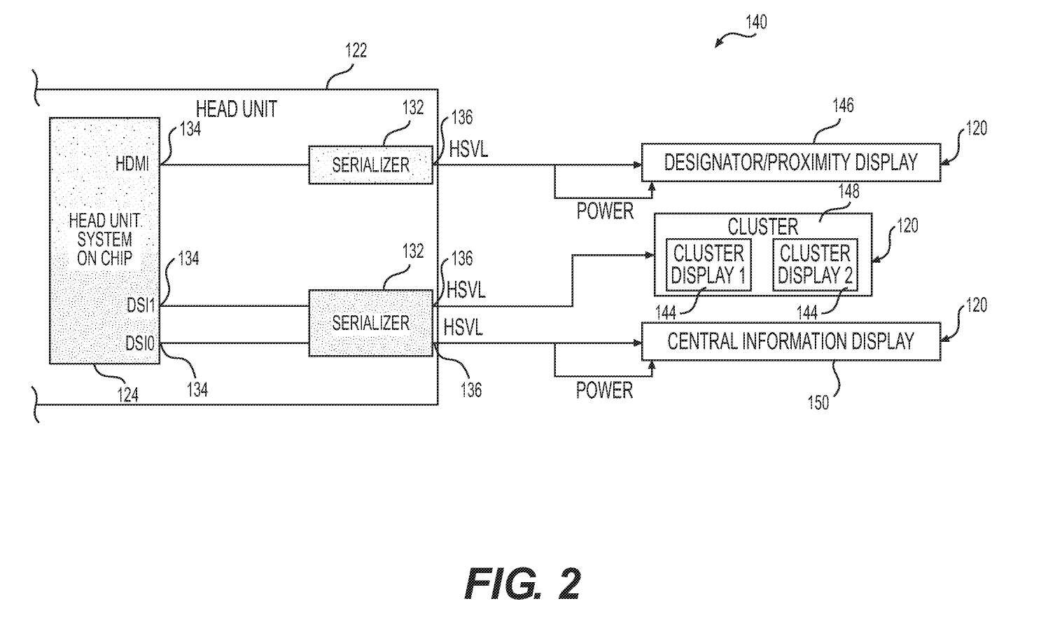

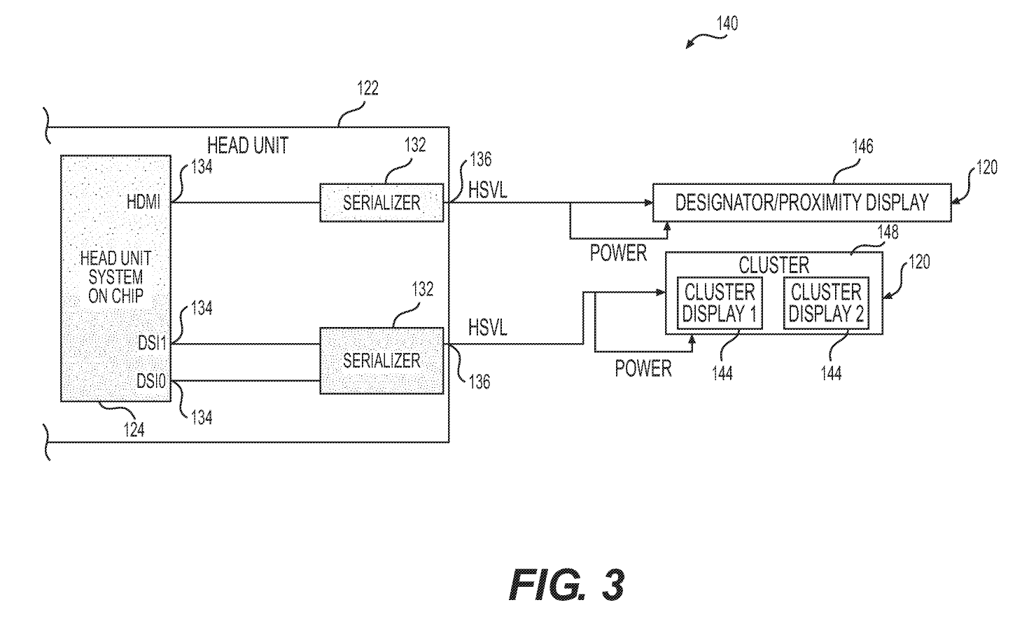

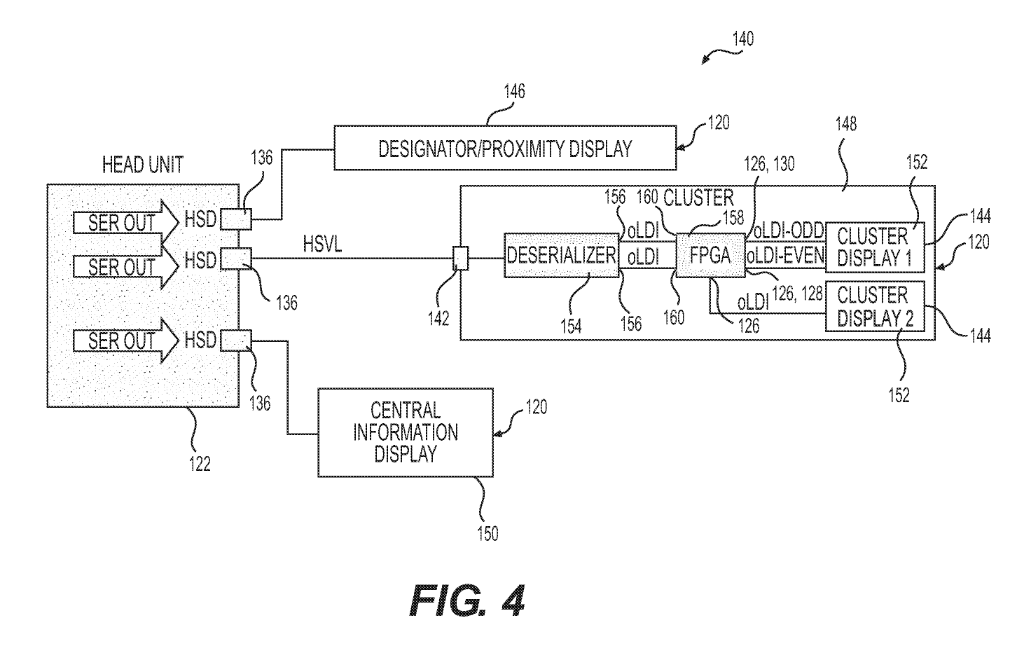

Referring to the remaining Figures, wherein like numerals indicate corresponding parts throughout the several views, a video link system 140, 240, 340 of the present invention is provided. A first embodiment of the video link system 140 of the present disclosure is shown in FIGS. 2-4 and includes a head unit 122 that includes a SOC or controller 124. The controller 124 includes a plurality of data ports 134 (labelled HDMI, DSI1, and DSI0 in FIGS. 2 and 3 and HSD in FIG. 4) and a plurality of video output ports 136 for outputting video. The head unit 122 also includes a serializer 132 electrically connected to one of the plurality of data ports 134 and to the plurality of video output ports 136 for serializing video output from the controller 124 and outputting a serial video stream on the plurality of video output ports 136. As shown in FIGS. 2 and 3, more than one serializer 132 may be used and these serializers 132 may be symmetrical (e.g., MAX9291 or MAX96757 from Maxim Integrated Products), rather than asymmetrical. The video output ports 136 of the head unit 122 may be adapted to output power along with the serial output stream; yet, it should be understood that the video output ports 136 may not output power.

The video link system 140 additionally includes at least one display assembly 120 including a video input port 142 and at least one display panel 144. The at least one display assembly 120 can, for example, include a designator or proximity display 146, a cluster 148, and a central information display 150 and power can be provided to both the designator or proximity display 146 and the central information display 150 (FIG. 2). If the cluster 148 is alone (no central information display 150), power may be provided to the cluster 148, for example (FIG. 3). The at least one display panel 144 of the cluster 148 can include a first cluster display panel 144 and a second cluster display panel 144. Each of the at least one display panels 144 defines a display area 152 having a display area size and can be coupled to the video input port 142 for displaying video output from the head unit 122 in the display area 152.

The at least one display assembly 120 also includes a deserializer 154 (FIG. 4) electrically connected to the video input port 142 and including a plurality of deserializer ports 156 for deserializing the serial video stream from the serializer 132 of the head unit 122 and outputting an intermediate digital display stream on the plurality of deserializer ports 156. The serializer 132 of the head unit 122 and the deserializer 154 of the at least one display assembly 120 are of the type to communicate via a High Speed Video Link (HSVL) and the serial video stream is a High Speed Video Link video stream. The deserializer 154 utilized can, for example, be a Maxim Integrated Products MAX96754 or MAX96752. According to an aspect, the HSVL video stream is a Gigbit Multimedia Serial Link (GMSL) type 2 video stream, however, other HSVL video streams may be utilized, such as a GMSL type 1 video stream. If GMSL type 1 is needed for the central information display 150 and/or cluster 148 alone, the MAX96791 serializer 132 may be utilized, for example.

The controller 124 of the head unit 122 is configured to process a plurality of designated video frames (e.g., designated for the first cluster 148 display panel 144 and the second cluster 148 display panel 144) for outputting to the at least one display assembly 120 (e.g., cluster 148). The controller 124 is also configured to pack the plurality of designated video frames into the video output.

The at least one display assembly 120 includes a de-multiplexing or unpacking unit 158 having a plurality of unpacking unit inputs 160 electrically connected to the plurality of deserializer ports 156 and having a plurality of unpacking unit outputs 126 electrically connected to the at least one display panel 144. According to an aspect, the unpacking unit 158 is a field programmable gate array (FPGA); however it should be appreciated that the unpacking unit 158 could comprise another integrated circuit or processing unit. The plurality of unpacking unit outputs 126 can include a plurality of low voltage differential signaling (LVDS) display interface outputs 128, 130, for instance. According to an aspect of the disclosure, the low voltage differential signaling display interface outputs 128, 130 can include an even low voltage differential signaling display interface (LDI) output 128 and an odd low voltage differential signaling display interface (LDI) output 130 (FIG. 4). The unpacking unit 158 is configured to process the intermediate digital display stream from the deserializer 154. The unpacking unit 158 may include at least one line buffer for processing the intermediate digital display stream. The unpacking unit 158 is additionally configured to output an unpacked (de-multiplexed) digital display output on the plurality of unpacking unit outputs 126 to the at least one display panel 144.

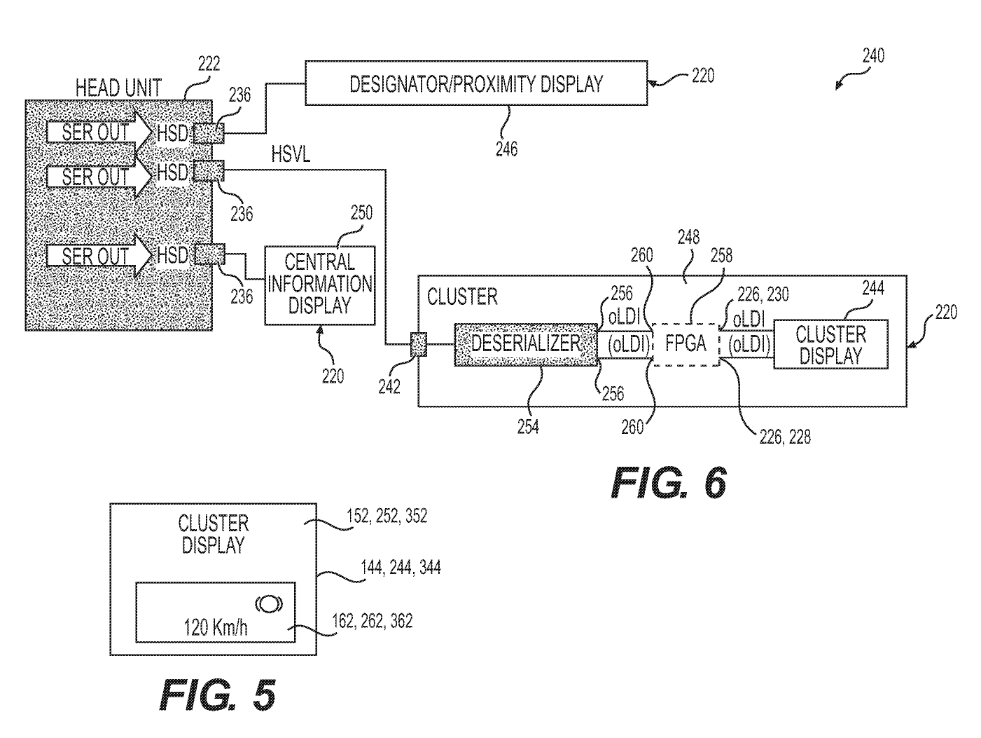

The intermediate digital display stream may include a region of interest 162, 262, 362 to be displayed on a portion of the display area 152, 252, 352 as shown in FIG. 5. In such an instance, processing of the intermediate digital display stream from the deserializer 154, 254, 354 of the unpacking unit 158, 258, 358 includes computing a check sum for the region of interest 162, 262, 362. The processing of the intermediate digital display stream from the deserializer 154, 254, 354 of the unpacking unit 158, 258, 358 can also include communicating the check sum to the deserializer 154, 254, 354 to be sent back to the controller 124, 224, 324 of the head unit 122, 222, 322 (via HSVL/LVDS return channels). Consequently, the controller 124, 224, 324 of the head unit 122, 222, 322 may be configured to compute an expected check sum for the serial video stream corresponding to the region of interest 162, 262, 362 and compare the check sum to the expected check sum. The region of interest 162, 262, 362 can correspond to a telltale and/or a warning message; however, it should be appreciated that the region of interest 162, 262, 362 can correspond to other video of the intermediate digital display stream. Additionally, multiple regions of interest 162, 262, 362 can be analyzed as well. The analysis of the region of interest 162, 262, 362 can help meet safety requirements, such as ISO 26262.

Additionally, the head unit 122, 222, 322 can send data describing the icons expected to be displayed (e.g., telltales and/or warning messages) and their expected positions (i.e., regions of interest 162, 262, 362) in the image or video and then the unpacking unit 158, 258, 358 can compare this received data to the actual image content (e.g., the intermediate digital display stream) being displayed and to send back the result of the comparison to the head unit 122, 222, 322. In addition, in case of defect (i.e., the actual image content not matching the data describing the icons expected to be displayed), the unpacking unit 158, 258, 358 could replace the missing/corrupt data by the correct icon data it has received from the head unit 122, 222, 322.

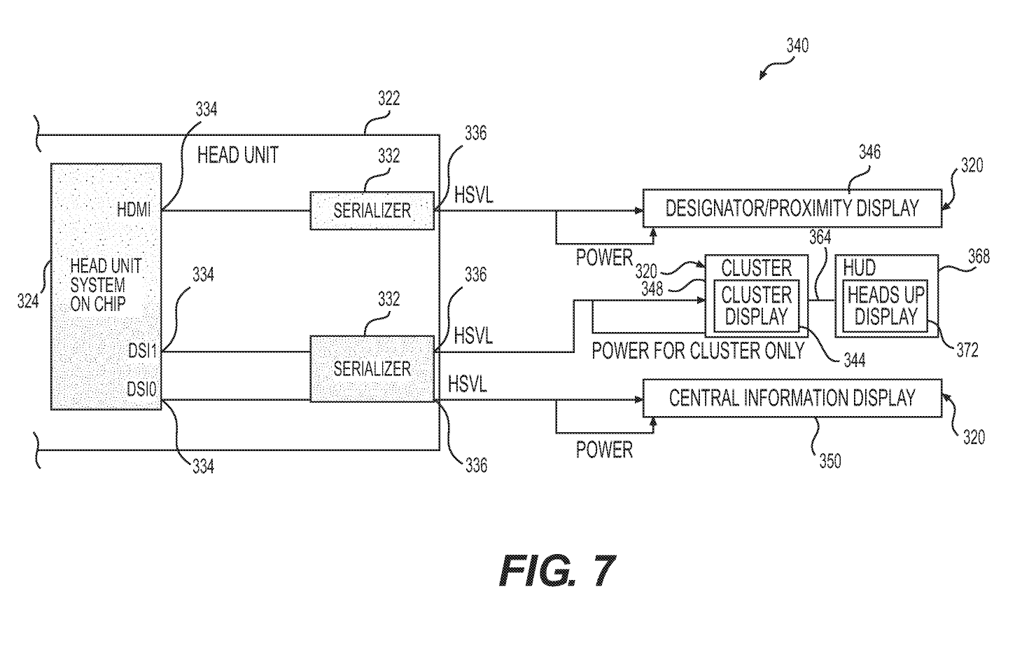

As best shown in FIG. 6, a second embodiment of the video link system 240 is provided, with like numerals, separated by a factor of 100, being used to show features corresponding to the first embodiment discussed above. The plurality of unpacking unit outputs 226 of the second embodiment of the video link system 240 also includes an even low voltage differential signaling display interface output 228 and an odd low voltage differential signaling display interface output 230; however, the at least one display assembly 220 of second embodiment only includes a single display panel 244. Nevertheless, the unpacking unit 258 remains useful, because although it is not outputting the unpacked digital display output on the plurality of unpacking unit outputs 226 to more than one display panel 244, the unpacking unit 258 can still carry out the analysis of the region of interest 262 as described above (e.g., for a telltale) to confirm that whatever is displayed in the region of interest 262 is displayed properly.

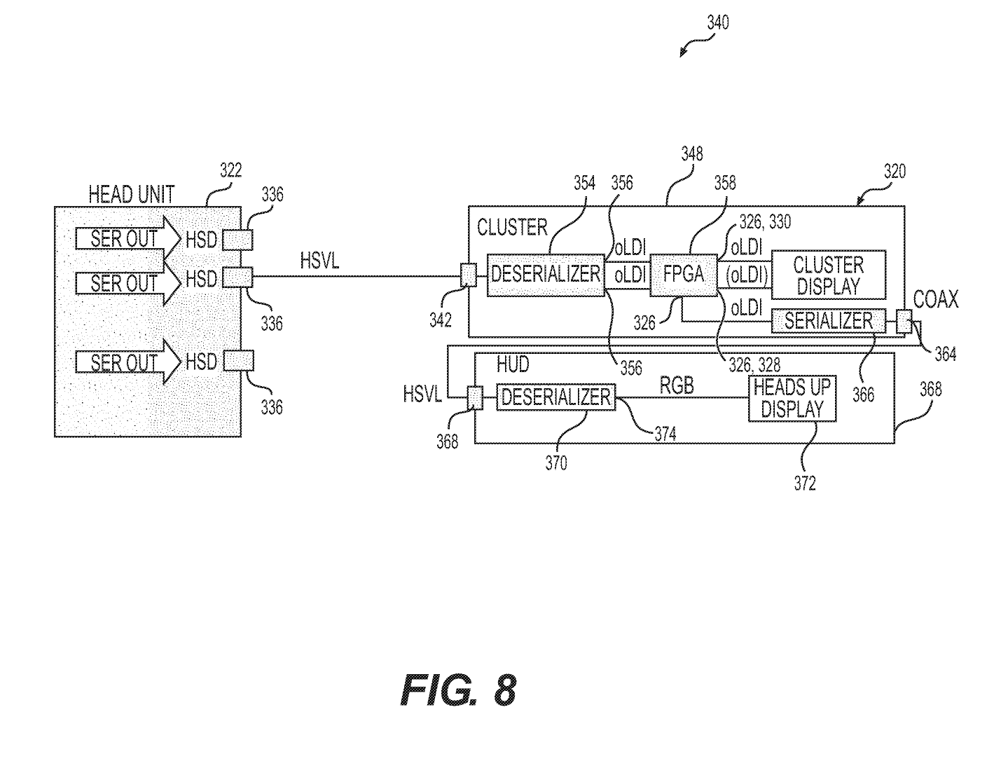

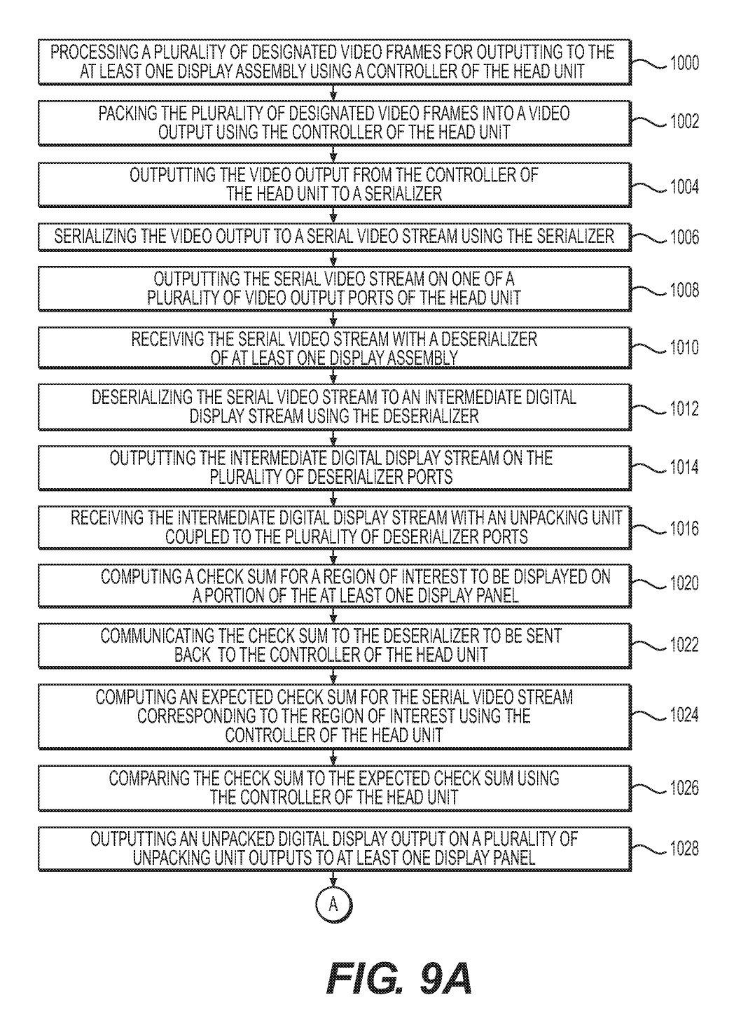

Referring now to FIGS. 7 and 8, a third embodiment of the video link system 340 is provided, with like numerals, separated by a factor of 200, being used to show features corresponding to the first embodiment discussed above. The at least one display assembly 320 of the third embodiment includes an interposed output port 364. The at least one display assembly 320 also includes a secondary serializer 366 coupled to the interposed output port 364 and to the plurality of unpacking unit outputs 326 for serializing the unpacked digital display output from the plurality of unpacking unit outputs 326 and outputting a secondary serial video stream on the interposed output port 364 (FIG. 8). At least one ancillary display unit 368 is coupled to the interposed output port 364 and includes an ancillary deserializer 370 having an ancillary deserializer port 374 and coupled to the interposed output port 364 and an ancillary display panel 372 coupled to the ancillary deserializer 370. As shown in FIG. 8, the ancillary display unit 368 can be a head up display (HUD) and the ancillary display panel 372 can be a HUD panel.

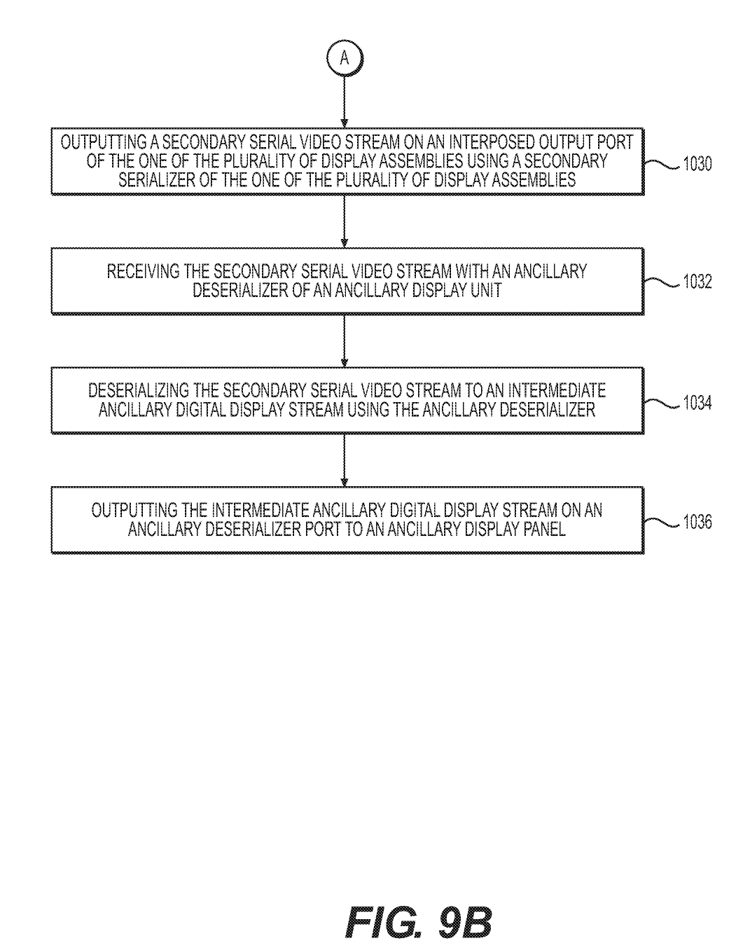

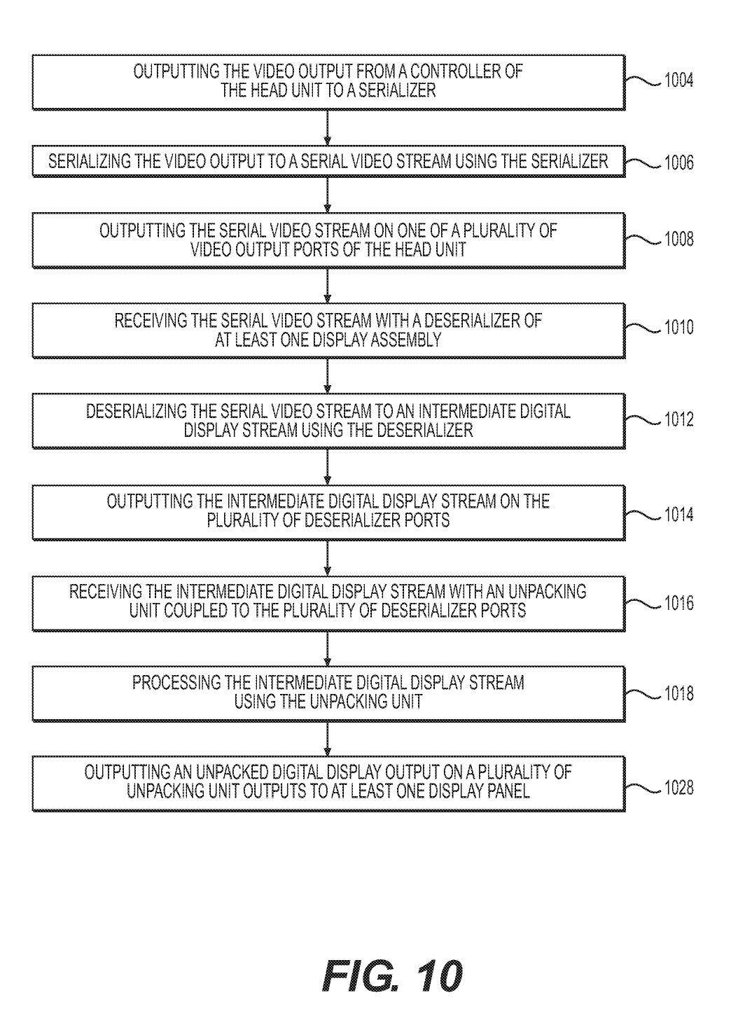

As shown in FIGS. 9A, 9B, and 10, a method of providing video to at least one display assembly 120, 220, 320 from a head unit 122, 222, 322 is also provided. The method begins by 1000 processing a plurality of designated video frames for outputting to the at least one display assembly 120, 220, 320 using a controller 124, 224, 324 of the head unit 122, 222, 322. The method continues with the step of 1002 packing the plurality of designated video frames into a video output using the controller 124, 224, 324 of the head unit 122, 222, 322. The method then includes the step of 1004 outputting the video output from a controller 124, 224, 324 of the head unit 122, 222, 322 to a serializer 132, 232, 332. The method continues with the step of 1006 serializing the video output to a serial video stream using the serializer 132, 232, 332. Next, 1008 outputting the serial video stream on one of a plurality of video output ports 136, 236, 336 of the head unit 122, 222, 322.

The method can proceed with the step of 1010 receiving the serial video stream with a deserializer 154, 254, 354 of at least one display assembly 120, 220, 320. The method also includes the step of 1012 deserializing the serial video stream to an intermediate digital display stream using the deserializer 154, 254, 354. The method continues by 1014 outputting the intermediate digital display stream on the plurality of deserializer ports 156, 256, 356. The method also includes the steps of 1016 receiving the intermediate digital display stream with an unpacking unit 158, 258, 358 coupled to the plurality of deserializer ports 156, 256, 356 and 1018 processing the intermediate digital display stream using the unpacking unit 158, 258, 358. The step of 1018 processing the intermediate digital display stream using the unpacking unit 158, 258, 358 may include the step of 1020 computing a check sum for a region of interest 162, 262, 362 to be displayed on a portion of the at least one display panel 144, 244, 344. The step of 1018 processing of the intermediate digital display stream using the unpacking unit 158, 258, 358 can also include the steps of 1022 communicating the check sum to the deserializer 154, 254, 354 to be sent back to the controller 124, 224, 324 of the head unit 122, 222, 322 and 1024 computing an expected check sum for the serial video stream corresponding to the region of interest 162, 262, 362 using the controller 124, 224, 324 of the head unit 122, 222, 322. In this case, the method can also include 1026 comparing the check sum to the expected check sum using the using the controller 124, 224, 324 of the head unit 122, 222, 322. The next step of the method is 1028 outputting an unpacked digital display output on a plurality of unpacking unit outputs 126, 226, 326 to at least one display panel 144, 244, 324.

As discussed above, the head unit 122, 222, 322 can send data describing the icons expected to be displayed (e.g., telltales and/or warning messages) and their expected positions (i.e., regions of interest 162, 262, 362) in the image or video and then the unpacking unit 158, 258, 358 can compare this received data to the actual image content (e.g., the intermediate digital display stream) being displayed and to send back the result of the comparison to the head unit 122, 222, 322. Thus, the method may include sending data describing the region of interest 162, 262, 362 expected to be displayed and their expected positions in the image or video using the head unit 122, 222, 322. The step of 1018 processing the intermediate digital display stream using the unpacking unit 158, 258, 358 can therefore include comparing data describing the region of interest 162, 262, 362 expected to be displayed to the intermediate digital display stream using the unpacking unit 158, 258, 358 and sending a result of the comparison to the head unit 122, 222, 322 using the unpacking unit 158, 258, 358. Additionally, the step of 1018 processing the intermediate digital display stream using the unpacking unit 158, 258, 358 can include replacing missing/corrupt data by the data describing the region of interest 162, 262, 362 expected to be displayed received from the head unit 122, 222, 322 in the intermediate digital display stream using the unpacking unit 158, 258, 358.

In the event that the video link system 340 includes an ancillary display panel 372, the method can also include the step of 1030 outputting a secondary serial video stream on an interposed output port 364 of the one of the plurality of display assemblies 320 using a secondary serializer 366 of the one of the plurality of display assemblies 320. The method can also include the step of 1032 receiving the secondary serial video stream with an ancillary deserializer 370 of an ancillary display unit 368. The method can then proceed with the steps of 1034 deserializing the secondary serial video stream to an intermediate ancillary digital display stream using the ancillary deserializer 370 and 1036 outputting the intermediate ancillary digital display stream on an ancillary deserializer port 374 to an ancillary display panel 372.

Obviously, many modifications and variations of the claimed invention are possible in light of the above teachings and may be practiced otherwise than as specifically described while within the scope of the appended claims. These antecedent recitations should be interpreted to cover any combination in which the inventive novelty exercises its utility.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

We claim:

1. A video link system for multiple displays, comprising:
a head unit including a controller for outputting video and a serializer coupled to the controller to serialize the video output from the controller and output a serial video stream;
at least one display assembly coupled to the head unit and including at least one display panel to display video output from the head unit;
the at least one display assembly including a deserializer to deserialize the serial video stream from the serializer of the head unit and output an intermediate digital display stream;
the at least one display assembly including an unpacking unit having a plurality of unpacking unit inputs coupled to the deserializer and to the at least one display panel and configured to:
process the intermediate digital display stream from the deserializer, and
output an unpacked digital display output to the at least one display panel.

2. The video link system as set forth in claim 1, wherein the at least one display panel defines a display area and the intermediate digital display stream includes a region of interest to be displayed on a portion of the display area and wherein processing of the intermediate digital display stream from the deserializer of the unpacking unit includes computing a check sum for the region of interest.

3. The video link system as set forth in claim 2, wherein the processing of the intermediate digital display stream from the deserializer of the unpacking unit includes communicating the check sum to the deserializer to be sent back to the controller of the head unit and the controller of the head unit is configured to:
compute an expected check sum for the serial video stream corresponding to the region of interest; and
compare the check sum to the expected check sum.

4. The video link system as set forth in claim 2, wherein the region of interest corresponds to one of a telltale and a warning message.

5. The video link system as set forth in claim 1, wherein the controller of the head unit is configured to:
process a plurality of designated video frames for outputting to the at least one display assembly using the controller of the head unit; and
pack the plurality of designated video frames into the video output using controller of the head unit.

6. The video link system as set forth in claim 1, wherein the unpacking unit includes at least one line buffer for processing the intermediate digital display stream.

7. The video link system as set forth in claim 1, wherein the unpacking unit includes a plurality of unpacking unit outputs and the plurality of unpacking unit outputs includes a plurality of low voltage differential signaling display interface outputs.

8. The video link system as set forth in claim 7, wherein the low voltage differential signaling display interface outputs includes an even low voltage differential signaling display interface output and an odd low voltage differential signaling display interface output.

9. The video link system as set forth in claim 1, wherein the head unit includes a plurality of video output ports for outputting the serial video stream and the plurality of video output ports of the head unit are adapted to output power along with the serial output stream.

10. The video link system as set forth in claim 1, wherein the serializer of the head unit and the deserializer of the at least one display assembly are of the type to communicate via a Gigabit Multimedia Serial Link and the serial video stream is a Gigabit Multimedia Serial Link video stream.

11. A display assembly for displaying video from a head unit having a serializer, comprising:
at least one display panel and a video input port coupled to the at least one display panel to display video output from the head unit;
a deserializer electrically connected to the video input port and including a plurality of deserializer output ports to deserialize the serial video stream from the serializer of the head unit and output an intermediate digital display output on the plurality of deserializer output ports;
an unpacking unit having a plurality of unpacking unit inputs electrically connected to the plurality of deserializer output ports and having a plurality of unpacking unit outputs electrically connected to the at least one display panel to process the intermediate digital display output from the deserializer and configured to process the intermediate digital display output from the deserializer and output an unpacked digital display output on the plurality of unpacking unit outputs to the at least one display panel.

12. The display assembly as set forth in claim 11, further including an interposed output port and a secondary serializer coupled to the interposed output port and to the plurality of unpacking unit outputs for serializing the unpacked digital display output from the plurality of unpacking unit outputs and outputting a secondary serial video stream on the interposed output port and wherein at least one ancillary display unit is coupled to the interposed output port and includes an ancillary deserializer coupled to the interposed output port and an ancillary display panel coupled to the ancillary deserializer.

13. The display assembly as set forth in claim 11, wherein the unpacking unit includes at least one line buffer for processing the intermediate digital display stream.

14. The display assembly as set forth in claim 11, wherein the intermediate digital display stream includes a region of interest to be displayed on a portion of the display area and wherein processing of the intermediate digital display stream from the deserializer of the unpacking unit includes computing a check sum for the region of interest.

15. The display assembly as set forth in claim 11, wherein the unpacking unit is a field programmable gate array.

16. A method of providing video to at least one display assembly from a head unit, comprising the steps of:
outputting a video output from a controller of the head unit to a serializer;
serializing the video output to a serial video stream using the serializer;
outputting the serial video stream on one of a plurality of video output ports of the head unit;
receiving the serial video stream with a deserializer of at least one display assembly;
deserializing the serial video stream to an intermediate digital display stream using the deserializer;
outputting the intermediate digital display stream on a plurality of deserializer ports;
receiving the intermediate digital display stream with an unpacking unit coupled to the plurality of deserializer ports;
processing the intermediate digital display stream using the unpacking unit; and
outputting an unpacked digital display output on a plurality of unpacking unit outputs to at least one display panel.

17. The method as set forth in claim 16, further including the steps of:
processing a plurality of designated video frames for outputting to the at least one display assembly using the controller of the head unit; and
packing the plurality of designated video frames into the video output using the controller of the head unit.

18. The method as set forth in claim 16, wherein the step of processing the intermediate digital display stream using the unpacking unit includes the computing a check sum for a region of interest to be displayed on a portion of the at least one display panel.

19. The method as set forth in claim 18, wherein the step of processing of the intermediate digital display stream using the unpacking unit further includes communicating the check sum to the deserializer to be sent back to the controller of the head unit;
computing an expected check sum for the serial video stream corresponding to the region of interest using the controller of the head unit; and
comparing the check sum to the expected check sum using the using the controller of the head unit.

20. The method as set forth in claim 16, further including the steps of:
outputting a secondary serial video stream on an interposed output port of the one of the plurality of display assemblies using a secondary serializer of the one of the plurality of display assemblies;
receiving the secondary serial video stream with an ancillary deserializer of an ancillary display unit;
deserializing the secondary serial video stream to an intermediate ancillary digital display stream using the ancillary deserializer;
outputting the intermediate ancillary digital display stream on a plurality of ancillary deserializer ports to an ancillary display panel.
